(19) United States
(12) Patent Application Publication
(10) Pub. No.: US 2020/0122449 A1
(43) Pub. Date: Apr. 23, 2020

(54) METHOD OF MANUFACTURING A LIGHT CONVERTING DEVICE

(71) Applicant: Lumileds Holding B.V., Schiphol (NL)

(72) Inventors: Rainald Gierth, Aachen (DE); Claudia Goldmann, Aachen (DE); Josef Andreas Schug, Aachen (DE)

(21) Appl. No.: 16/659,352

(22) Filed: Oct. 21, 2019

(30) Foreign Application Priority Data
Oct. 22, 2018 (EP) 18201691.5

(51) Int. Cl. B32B 37/12; F21V 9/30; B32B 37/18; B32B 38/00; B32B 7/12; B32B 9/04; B32B 9/00

(52) U.S. Cl. CPC B32B 37/12; F21V 9/30; B32B 37/18; F21S 41/176; B32B 7/12; B32B 9/041; B32B 9/005; B32B 38/0004

(57) ABSTRACT

In a method of manufacturing light converting devices each in form of a converter element attached on a carrier substrate, a carrier wafer and a converter wafer with lateral dimensions larger than the lateral dimensions of the converter elements are provided. A bond layer is applied to one of the carrier wafer and the converter wafer, and the converter wafer is securely fixed on the carrier wafer via the bond layer, thereby forming a wafer stack. The wafer stack is then separated into pieces such that first of said pieces have the lateral dimensions of the converter elements and do not share any edge with an edge of the wafer stack, said first pieces forming the light converting devices. With this method, a light converting device without any squeezed out bonding material, e.g. glue, is achieved.

### CROSS REFERENCE TO RELATED APPLICATIONS

This application claims priority to European Patent Application No. 18201691.5 filed on Oct. 22, 2018 titled “A METHOD OF MANUFACTURING A LIGHT CONVERTING DEVICE.” European Patent Application No. 18201691.5 is incorporated herein by reference.

### TECHNICAL FIELD AND BACKGROUND

The present invention relates to a method of manufacturing a light converting device, said light converting device being formed of a converter element bonded on a carrier substrate, said converter element converting light of a first wavelength region into light of a second wavelength region. The invention also relates to a light converting device and to a white light source using such a light converting device.

White light sources are required in the field of illumination applications, for example in the automotive sector. White light sources are mostly based on conversion of blue light, in particular blue laser light, by an appropriate converting material into yellow light. The mixture of the remaining, i.e. not converted, blue light with the yellow light sums up to the desired white light. A light converting device for such light conversion typically comprises a converter element attached to, e.g. glued on, a carrier substrate which also serves as a heat sink for the thermal losses in the converter element. If gluing is used as the bonding technique, the glue layer should be extremely thin to reduce thermal isolation of the converter element. Principally, two architectures are possible for such a light converting device, a transmissive architecture in which the light passes through the carrier substrate, and a reflective architecture in which the carrier substrate has a high-reflective surface reflecting the original and converted light back through the converter element. The reflective architecture is advantageous in view of heat dissipation since the carrier substrate can be formed of a metallic material on which a metallic mirror is formed.

The dimensions of the converter element provided e.g. in form of a platelet are small, with typically <1 mm edge length and <70 μm thickness for laser-based white light sources. Due to the small lateral dimensions (edge length) the fabrication of such a light convesting device is difficult. Glues (e.g. silicones) suited to withstand the blue light irradiation and the thermal stresses induced by both conversion losses in the converter element and ambient temperatures and which are soft enough to provide good adhesion also under mechanical stress feature viscosities in the order of few Pascal seconds. On one hand, sub-nano-liter dispensing needed to achieve a thin glue layer is extremely difficult to realize for such glues. Advanced jet valves claim to be capable to jet droplets in the range of nano-liters, but without purging the valve's exit nozzle often clogs and reproducibility of small volumes cannot be assured. On the other hand, the minimum glue volume required to actually bond the converter platelet to the carrier substrate is typically smaller than 0.5 nl. Typically, it is not possible to achieve a uniform and thin glue layer for attaching a converter platelet without significant squeeze-out of glue material at the borders of the converter element. This is exemplary shown in FIG. 1. The figure shows a converter element 1 glued to a carrier substrate 2 having a metallic mirror layer 3 on top by means of a glue 4. At the edges of the converter element 1 the glue 4 squeezes out and the squeeze-out material may creep up the edge of the converter element 1—as shown in FIG. 1—and contaminate its surface leading to optical deterioration. The glue layer can also act as a light guide. Light emitted into the squeeze-out region is trapped and lost for conversion. A loss in intensity and a shift in colour point can then occur. FIG. 1 also indicates the impinging blue light 5 that is converted in the converter element 1 in part to yellow light—not shown in the figure—and reflected together with the yellow light back through the converter element 1.

### SUMMARY OF THE INVENTION

It is an object of the present invention to provide a method of manufacturing a light converting device of the above design in which the light converting device is reproducibly fabricated without any squeezed-out bonding material deteriorating the function of the device.

The object is achieved with the method according to claim 1. Advantageous embodiments of the proposed method are subject matter of the dependent claims or are disclosed in the subsequent portions of the description. Claim 10 defines a light converting device which can be manufactured with the proposed method. Claim 13 relates to the use of such a light converting device for realizing a white light source.

The proposed method relates to the manufacturing of a light converting device which is formed of a converter element bonded, in particular glued or soldered, on a carrier substrate, wherein the converter element is designed to convert light of a first wavelength region, e.g. blue light, into light of a second wavelength region, e.g. yellow light. In the proposed method, a carrier wafer and a converter wafer are used with lateral dimensions exceeding the lateral dimensions of the converter element, preferably such that the lateral dimensions allow to manufacture several of the light converting devices from the carrier wafer and the converter wafer. A bond layer is applied to one of the carrier wafer and the converter wafer, and the converter wafer is securely fixed on the carrier wafer via the bond layer, thereby forming a wafer stack. Several pieces having the lateral dimensions of the converter element are then cut out from this wafer stack such that the pieces do not include any edge portion of the wafer stack. Each of these pieces then forms a light converting device.

The term “wafer” originating from semiconductor technology is used in the present specification and claims in a broader sense of a substrate or plate of any kind of material appropriate for the realization of a light converting device. Such a wafer may have e.g. a circular or rectangular shape and has substantially larger (lateral) dimensions than a single light converting device to be manufactured. The lateral dimensions are the dimensions perpendicular to the thickness of the wafer.

The attachment of the converter element to the carrier substrate according to the present invention is done on wafer level, i.e. a large converter wafer is attached to a large carrier wafer. When using a glue for bonding according to a preferred embodiment, the glue volume to be applied can thus be increased without risking glue creeping up at the sides of the converter elements deteriorating the converter element surfaces or trapping light within the glue; thus avoiding light losses at the level of the single light converting devices (platelet level). The squeeze-out of the glue only affects portions located at the edge of the wafer that would anyhow be discarded. The separation or singulation of individual converter devices is done on the converter-glue-carrier sandwich after final curing. This allows for the manufacturing of squeeze-out free light converting devices.

With the proposed method, the maximum glue volume to be applied is not restricted to the size requirement of an individual converter element anymore. Several alternatives for the application of volumes >>1 nl are conceivable, like time-pressure based dispensing or jetting or extruding the glue. The converter wafer may have a diameter sufficiently large to allow for singulating at least 4 individual light converting devices, preferably many more. The pick and place process of the wafer should allow for enough placement delay for the glue to be pressed down to a thickness of a few micrometers or less over the full surface. The cutting can for example be performed mechanically or also by laser treatment. For the separation or singulation a dicing process is a suitable method. The dicing can be performed in a one-step cutting through the wafer stack of carrier wafer and converter waver. As an alternative, the dicing may also be performed sequentially. The dicing may then stop after cutting one of the wafers, either the carrier wafer or the converter wafer. The remaining wafer may then be cut in a second step with adapted process settings.

In a light converting device manufactured according to the proposed method the lateral dimensions of the converter element thus coincide with the lateral dimensions of the carrier substrate and the converter element is accurately fitted to the carrier substrate. The light converting device does not show any squeezed-out bonding material, in particular glue, as appearing in prior art methods at the side faces of the light converting device. Such a light converting device may for example be used in a light source for white light, e.g. for a headlamp of a motor vehicle in the automotive sector. Such a light source, assuming it is laser-based, comprises one or several lasers or laser diodes and at least one of the above light converting devices. The light converting device is arranged to convert part of the light of said one or several lasers or laser diodes into converted light of another wavelength region, said light of said one or several lasers or laser diodes not converted summing up with said converted light to form white light.

The proposed method offers an additional advantage with respect to yield and process capability. The converter element is very thin and in case of ceramics, the ceramic base material is quite brittle. Reinforcing the converter wafer by attaching it to the carrier wafer in an early processing stage reduces the breakage loss while ejecting the platelets from a dicing or ejection tape. A further advantage relates to subsequent process steps, in particular to the application of a sidecoat. The application of a sidecoat around a thick substrate-converter sandwich or stack (of approximately 1 mm) is much easier than when depositing a sidecoat around a <<100 μm thin converter element where the jetted sidecoat droplets are much higher than the converter element and where special dispensing patterns and special material properties have to be selected in order to make such a dispensing process working at all. These complications are avoided when using the much larger sizes provided by the wafer level processing with subsequent cutting according to the present invention.

### SHORT DESCRIPTION OF THE DRAWINGS

The proposed method is described in the following by way of examples in connection with the accompanying figures. The figures show:

FIG. 1 a schematic view of a light converting device according to the prior art;

FIG. 2 a schematic view of a first phase of the proposed method; and

FIG. 3 a schematic view of several light converting devices according to the present invention after performing the final step of the proposed method.

### DESCRIPTION OF EMBODIMENTS

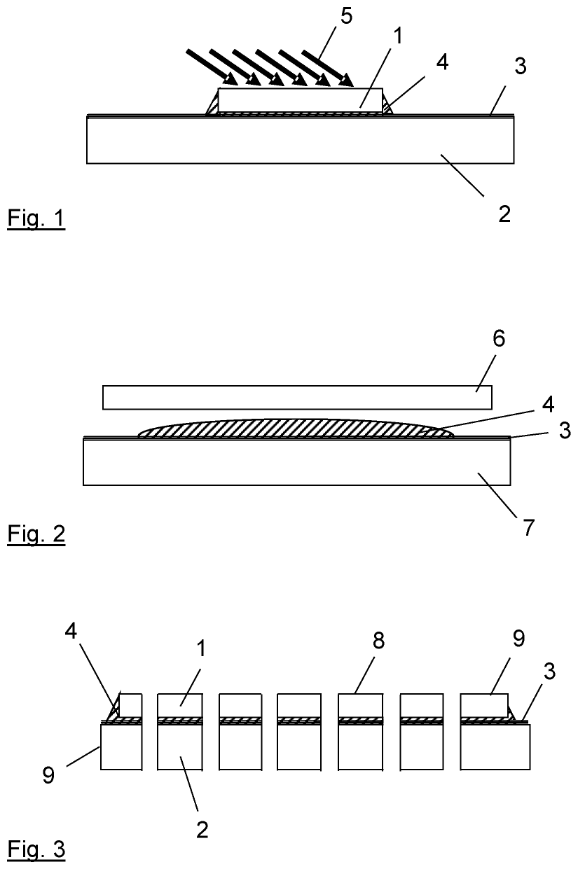

The problems arising with the method of manufacturing a light converting device according to the prior art have already been explained in connection with FIG. 1 in the introductory portion of this description. The proposed method avoiding the drawbacks of the prior art is described in the following in an exemplary embodiment in which the converter element is attached to a carrier substrate having a mirror at the surface.

According to this example a carrier wafer (substrate) 7 and a converter wafer 6 are provided with lateral dimensions substantially larger than the lateral dimensions of the light converting devices to be manufactured. The lateral dimensions are e.g. the diameter in case of a circular wafer or the edge lengths in case of a rectangular wafer. The converter wafer 6 in this example is quadratic and has a diameter sufficiently large to allow for singulation of 5×5, i.e., 25, individual converter elements. The carrier wafer carries a layer or layer sequence forming a mirror 3 on top as can be seen from FIG. 2. The mirror can be formed of a metallic layer, of a dielectric layer or layer sequence, or of a combination of a metallic layer and a dielectric layer sequence. The bulk of the carrier wafer preferably consists of a metal or a ceramic material with good heat conductivity. A glue 4 is applied to the surface of the carrier wafer 7 in order to securely attach the converter wafer 6 to the carrier wafer 7. Due to the substantially larger lateral dimensions of the two wafers compared with the lateral dimensions of the light converting devices to be manufactured the maximum glue volume to be applied is not restricted by the size requirement of an individual converter element anymore. Therefore, glue volumes substantially larger than 1 nl can be applied for which different techniques can be used. FIG. 2 shows the glue 4 applied to the surface of the carrier wafer 7. After application of the glue 4 the converter wafer 6 is pressed against the carrier wafer 7 in order to achieve a thickness of the resulting glue layer of only a few μm or less, preferably <3 μm, more preferably <1 μm, over the full surface of the carrier wafer 7.

After final curing of the glue 4, the resulting wafer stack is separated into several pieces, e.g. using a dicing process. This separation or dicing step is performed such that several pieces corresponding to the to be manufactured light converting devices and having the dimensions of these devices are cut out of the wafer stack such that these light converting devices do not share any edge with the edges of the wafer stack. This is shown in FIG. 3 indicating different light converting devices 8 after separation of the wafer stack. The pieces 9 at the edges of the wafer stack are discarded. Only these edge pieces 9 show a squeezing-out of the glue 4. The manufactured light converting devices 8, however, do not show any squeeze-out material and do thus not have the problems of the light converting devices manufactured according to the prior art.

While the invention has been illustrated and described in detail in the drawings and forgoing description, such illustration and description are to be considered illustrative or exemplary and not restrictive. The invention is not limited to the disclosed embodiments. The proposed processing on wafer level can also be combined with other bonding techniques such as e.g. soldering. Other variations to the disclosed embodiments can be understood and effected by those skilled in the art in practicing the claimed invention from a study of the drawings, the disclosure, and the appended claims. Thus, e.g., the invention might not only be applied to light converting devices to be used together with laser-based light sources but also for light converting devices for other light sources such as e.g. light emitting diodes (LEDs).

In the claims, the word “comprising” does not exclude other elements or steps and the indefinite articles “a” or “an” do not exclude a plurality. The mere fact that certain measures are recited in mutually different dependent claims does not indicate that a combination of these measures cannot be used to advantage. Any reference signs in the claims should not be construed as limiting the scope of the invention.

### LIST OF REFERENCE SIGNS

1 converter element
2 carrier substrate
3 mirror/mirror layer
4 glue
5 blue light
6 converter wafer
7 carrier wafer
8 light converting device
9 edge pieces

1. A method of manufacturing light converting devices each being formed of a converter element attached on a carrier substrate, said converter element converting light of a first wavelength region into light of a second wavelength region,
the method comprising:
providing a carrier wafer and a converter wafer with lateral dimensions larger than lateral dimensions of the converter elements,
applying a bond layer to one of the carrier wafer and the converter wafer and securely fixing the converter wafer on the carrier wafer via the bond layer, thereby forming a wafer stack,
separating the wafer stack into pieces such that first of said pieces have the lateral dimensions of the converter elements and do not share any edge with an edge of the wafer stack, said first pieces forming the light converting devices.

2. The method according to claim 1,
wherein the carrier wafer and the converter wafer are provided with lateral dimensions allowing to manufacture several of the light converting devices from the carrier wafer and the converter wafer.

3. The method according to claim 1,
wherein said carrier wafer is formed of a metallic material and comprises a layer or layer sequence forming a mirror on its surface.

4. The method according to claim 1,
wherein said bond layer is formed of a glue.

5. The method according to claim 4,
wherein said glue is pressed to a thickness of <3 μm between the converter wafer and the carrier wafer.

6. The method according to claim 1,
wherein the separation of the wafer stack into pieces is performed such that the converter elements have a rectangular shape with edge lengths of <1 mm.

7. The method according to claim 1,
wherein said converter wafer is provided with a thickness of <70 μm.

8. The method according to claim 1,
wherein said converter wafer is provided of a luminescent ceramics.

9. The method according to claim 1,
wherein the separation of the wafer stack into pieces is performed as a two-step process in which a first one of the converter wafer and carrier wafer is cut with first cutting parameters adapted to a material of this first wafer, and then a second one of the converter wafer and carrier wafer is cut with second cutting parameters adapted to a material of this second wafer.

10. The light converting device being manufactured by the manufacturing method according to claim 1, and the light converting device being formed of the converter element bonded by the bond layer on the carrier substrate, said converter element converting the light of the first wavelength region into the light of the second wavelength region, wherein the lateral dimensions of the converter element coincide with lateral dimensions of the carrier substrate, said converter element being accurately fitted to said carrier substrate, and wherein there is no material of the bond layer squeezed-out at side faces of the light converting device.

11. The light converting device according to claim 10,
wherein said carrier substrate is formed of a metallic material and comprises a layer or layer sequence forming a mirror on its surface.

12. The light converting device according to claim 10,
wherein said converter element has a rectangular shape with edge lengths of <1 mm and a thickness of <70 μm.

13. A light source for white light comprising one or several lasers or laser diodes and at least one light converting device according to claim 10,
wherein said light converting device is arranged to convert part of the light of said one or several lasers or laser diodes into converted light of another wavelength region, said light of said one or several lasers or laser diodes not converted summing up with said converted light to form white light.
